(19) United States
(12) Patent Application Publication
(10) Pub. No.: US 2024/0320545 A1
(43) Pub. Date: Sep. 26, 2024

(54) DEPLOYING ARTIFICIAL INTELLIGENCE (AI) MODELS AT LOCAL SITES

(71) Applicant: INTERNATIONAL BUSINESS MACHINES CORPORATION, Armonk, NY (US)

(72) Inventors: Eyal COHEN, Zichron Yaakov (IL); Roy ABITBOL, Zurit (IL); Jonathan Bnayahu, Haifa (IL)

(21) Appl. No.: 18/188,904

(22) Filed: Mar. 23, 2023

(51) Int. Cl. G06N 20/00

(52) U.S. Cl. CPC G06N 20/00

(57) ABSTRACT

Provided are techniques for deploying AI models at local sites. A selection of an Artificial Intelligence (AI) model template is received at a local site, where the AI model template is created at a remote site and is packaged in a transportable container. The AI model template in the transportable container is retrieved. A lifecycle of an AI model is orchestrated by: instantiating an AI model from the AI model template, retrieving data from one or more local data sources, training the AI model using the data, deploying the AI model as a service, monitoring the AI model for drift, and, in response to identifying drift, re-training the AI model.

### BACKGROUND

Embodiments of the invention relate to deploying Artificial Intelligence (AI) models at local (e.g., client) sites. In addition, embodiments of the invention relate to lifecycle management of AI models at the local sites.

Incorporating AI capabilities into existing applications is challenging. Currently, a data scientist develops an AI model in the lab, which includes pre-processing data, training the model on the data, fine-tuning the model, etc.

In many cases, after an AI model is developed (e.g., initially in the lab), it requires some effort to prepare the AI model before the AI model may be fully operational in production, let alone if the AI model is to be deployed in multiple sites (e.g., client sites), especially where remote access is not available and when the AI model is to be adapted to different and versatile data, such as proprietary client data.

Nowadays, at each of the multiple sites, the AI model is manually: configured, connected to a data source with data, trained on the data, deployed as a service, and continuously monitored at run time. There may also be additional manual work regarding caching, versioning, feedback collection, and governance.

Existing tools offer solutions for use by highly skilled data scientists. Existing AI solutions are typically one-off models, models that are highly customized for a specific purpose, or model-code releases handled by highly skilled data scientists with deep data-science and programming knowledge.

Thus, the barrier for adoption of AI applications is high.

### SUMMARY

In accordance with certain embodiments, a computer-implemented method comprising operations is provided for deploying AI models at local sites. In such embodiments, a selection of an Artificial Intelligence (AI) model template is received at a local site, where the AI model template is created at a remote site and is packaged in a transportable container. The AI model template in the transportable container is retrieved. A lifecycle of an AI model is orchestrated by: instantiating the AI model from the AI model template, retrieving data from one or more local data sources, training the AI model using the data, deploying the AI model as a service, monitoring the AI model for drift, and, in response to identifying drift, re-training the AI model.

In accordance with other embodiments, a computer program product is provided for deploying AI models at local sites. The computer program product comprises a computer readable storage medium having program code embodied therewith, the program code executable by at least one processor to perform operations for deploying the AI models at the local site. In such embodiments, a selection of an Artificial Intelligence (AI) model template is received at a local site, where the AI model template is created at a remote site and is packaged in a transportable container. The AI model template in the transportable container is retrieved. A lifecycle of an AI model is orchestrated by: instantiating the AI model from the AI model template, retrieving data from one or more local data sources, training the AI model using the data, deploying the AI model as a service, monitoring the AI model for drift, and, in response to identifying drift, re-training the AI model.

In accordance with yet other embodiments, a computer system is provided for deploying AI models at local sites. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for deploying the AI models at the local sites. In such embodiments, a selection of an Artificial Intelligence (AI) model template is received at a local site, where the AI model template is created at a remote site and is packaged in a transportable container. The AI model template in the transportable container is retrieved. A lifecycle of an AI model is orchestrated by: instantiating the AI model from the AI model template, retrieving data from one or more local data sources, training the AI model using the data, deploying the AI model as a service, monitoring the AI model for drift, and, in response to identifying drift, re-training the AI model.

These embodiments advantageously allow the AI model template to be created at a remote site, transported to a local site, and used to orchestrate a lifecycle of the AI model at the local site using data from one or more local data sources. Advantageously, the orchestration includes: instantiating the AI model from the AI model template, retrieving data from one or more local data sources, training the AI model using the data, deploying the AI model as a service, monitoring the AI model for drift, and, in response to identifying drift, re-training the AI model.

In additional embodiments, the AI model template is displayed in an AI model template catalog. This advantageously provides easy selection of the AI model template.

In yet additional embodiments, the AI model is configurable with configurable parameters. This advantageously enables customization of the AI model.

In other embodiments, lifecycle services of caching, versioning, and governance at the local site are provided. This advantageously allows these lifecycle services to be provided at the local site instead of provided from a remote site.

In yet other embodiments, a machine learning pipeline is used to perform the training of the AI model. This advantageously provides a technique for training the pipeline at the local site.

In further embodiments, feedback is received on the AI model and the AI model template and the AI model are updated based on the feedback.

In yet further embodiments, the AI model template is a formalized description of the AI model that allows transportability of the model, and code, metadata, and binary execution images are packaged in the AI model template. This advantageously enables the components used to instantiate the AI model to be transported from a remote site to a local (client) site and received in a formalized manner with one AI model template.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, an architecture for an AI model framework in accordance with certain embodiments.

FIG. 2 illustrates, in a block diagram functional components of the AI model framework in accordance with certain embodiments.

FIG. 3 illustrates, in a block diagram, a technology stack for an AI model framework in accordance with certain embodiments.

FIG. 4 illustrates an example of a lifecycle of an AI model in accordance with certain embodiments.

FIG. 5 illustrates components of an AI model template in accordance with certain embodiments.

FIGS. 6A, 6B, and 6C illustrate an example AI model template in accordance with certain embodiments.

FIGS. 7A and 7B illustrate an example AI model deployment configuration in accordance with certain embodiments.

FIG. 8 illustrates a Representational State Transfer (REST) interface in accordance with certain embodiments.

FIG. 9 illustrates a command line interface in accordance with certain embodiments.

FIG. 10 illustrates an example dashboard in accordance with certain embodiments.

FIG. 11 illustrates another example dashboard in accordance with certain embodiments.

FIG. 12 illustrates the models server 150 in accordance with certain embodiments.

FIG. 13 illustrates instantiation of models in accordance with certain embodiments.

FIGS. 14A and 14B illustrate, in a flowchart, operations for lifecycle management of an AI model in accordance with certain embodiments.

FIG. 15 illustrates a computing environment in accordance with certain embodiments.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments describe an AI model in a formalized manner in order to package that AI model in a transportable, containerized AI model unit. Embodiments accept and interpret the transportable, containerized AI model unit to instantiate the AI model, connect the AI model to a data source with data, train the AI model on the data, deploy the AI model as a service, and monitor the AI model at run time. Thus, embodiments, serve as an end-to-end lifecycle management for AI models. With embodiments, the AI model is automatically: configured, connected to a data source with data, trained on the data, deployed as a service, and continuously monitored at run time. With embodiments, the following are also automated: caching, versioning, feedback collection, and governance.

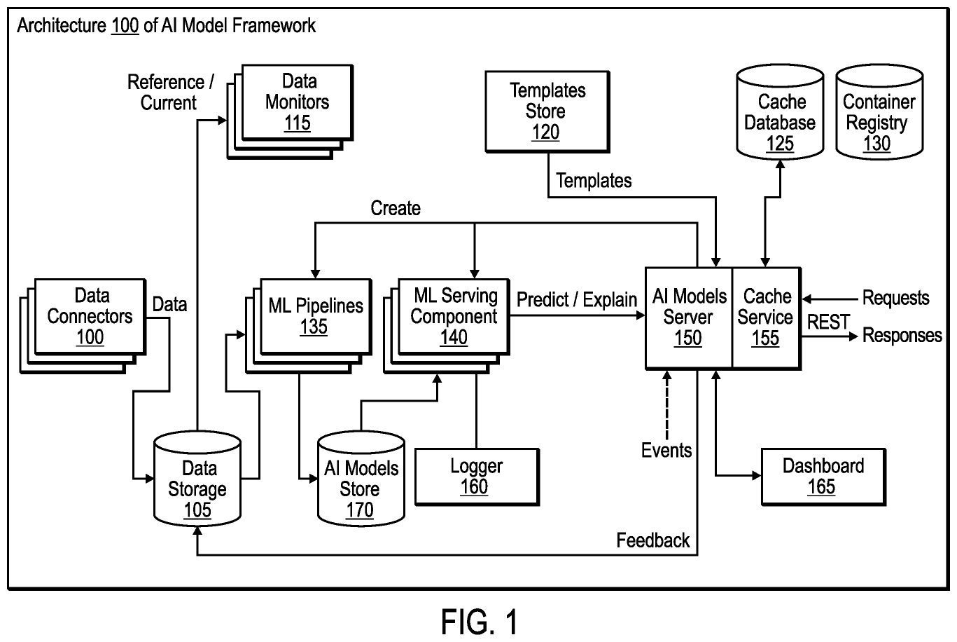

FIG. 1 illustrates, in a block diagram, an architecture 100 for an AI model framework in accordance with certain embodiments. In FIG. 1, the data connectors 110 may be described as an extensible library of add-on components that fetch data from data sources. For example, the data connectors 110 may perform transformations on the data and in accordance with the requirements of the AI models. Also, data connectivity is a service that the AI model framework provides for the deployed AI models. The data connectors 110 may load offline data. In certain embodiments, offline data may be described as historic data (e.g., data that may not relate to a current runtime), and the offline data is used for training the AI model. On the other hand, online data may be described as requiring inference after the AI model has been trained on the offline data.

The data monitors 115 may be described as an extensible library of add-on components that apply difference monitoring techniques on the AI models' data and the AI models' results. The data monitoring is a service that the AI model framework provides for the deployed AI models. The reference data may be described as the offline data upon which the AI model had been trained and which is used as a basis for drift analysis against the current (i.e., online) data. If the current data is different (e.g., in content, distribution, etc.) from the reference data, then the data monitors 115 determine that there is a drift from the data upon which the AI model was trained. Then, the AI model is re-trained to correct the drift.

The storage 105 includes local storage for AI models, data, binaries, feedback data, monitoring data, prediction results, etc. The storage 105 is accessible by the other components and services of FIG. 1.

The Machine Learning (ML) pipelines may be described as component for building and deploying ML workflows based on containers. Containers may be described as components that combine application source code with the operating system (OS) libraries and dependencies used to run that source code in any environment.

The ML serving component 140 serves the ML AI models (e.g., to clients). With embodiments, the ML serving component 140 hosts the AI model instances, and the AI model instances receive the predict/explain requests and perform inferencing. Inferencing includes generating predictions, classifications, and other outcomes. For example, a clustering AI model may output an inference (e.g., a classification).

Bottomline, we should consider altering the terminology throughout the document from prediction to inference.

The logger 160 may be described as a component for logging predictions and explanation results by the AI models, which may be used for further analysis and tracing. With embodiments, the explanations are aligned with the prediction results. The explanations provide additional metadata on top of the predictions. For example, the explanations may be text descriptions of the predictions, along with the key factors that led the AI model instance to make a certain prediction.

The AI models server 150 may be described as a component that orchestrates the lifecycle of the AI models end-to-end, which may include instantiating the AI model to providing lifecycle services of caching, versioning, and governance at the local site. In certain embodiments, orchestration includes: configuring and instantiating the AI model, connecting to a data source with data, training the AI model on the data, deploy the AI model as a service, and continuously monitoring the AI model at run time, while providing caching, versioning, feedback collection, and governance.

I think this is a key differentiator: none of the priors handles the entire lifecycle The AI models server 150 controls the flow of the AI models end to end, as well as connecting the lifecycle services. The AI models server 150 exposes an Application Programming Interface (API) for external applications or users. The AI models server 150 retrieves an AI model template from the templates store 120 in response to an API request and drives creation of an AI model from the AI model template using the ML pipelines 135 and the ML server component 140. The API request may be received via Representational State Transfer (REST). The AI models server 150 creates (i.e., trains and deploys using the pipeline 135) an AI model and provides a link to the AI model as a response to the request. In addition, the AI models server 150 connects and enforces various lifecycle policies.

In certain embodiments, data comes via the data connectors 110 and is stored at a storage. Then, when an ML pipeline 135 runs, the data flows into the ML pipeline 135, and the ML pipeline 135 uses the AI model template and the data to create the AI model. The AI model is the result of the ML pipeline 135 and is stored in the AI models store 170 after the pipeline ends. The AI model is also uploaded into the ML serving component 140 for deployment in order to serve inference requests.

The logger receives events whenever an operation on either the ML pipeline 135 or the ML serving component 140 starts or ends and performs logging. The templates store 120 may be described as an external or local service for storing AI model templates and serving the AI model templates in response to requests. The templates store 120 may reside in a central location serving multiple AI models servers.

The cache database 125 and the cache service 155 stores requests and responses to AI model instances in order to accelerate processing time and to reduce load on the inferring AI models. The cache service 155 may be described as part of the AI lifecycle services.

The container registry 130 may be described as an external service (external to the AI model framework) that is used to store container images, which are binary execution images.

The dashboard 165 may be described as a graphical user interface that allows an administrator (or other user) to interact with the AI models server 150. The dashboard 165 uses the exposed API of the AI models server 150.

In certain embodiments, the AI model template is packaged in the lab by a ML developer (or ML-Ops engineers or a similar role). The ML developer takes the raw code of the AI model and packages that code automatically by using a packaging tool (e.g., code/script). In alternative embodiments, the ML developer takes the raw code of the AI model and packages that code manually by following a set of guidelines. The result of this packaging is an AI model template, which is a transportable unit of deployable code, metadata, and binary execution images. The AI model templates are stored in the templates store 120, in a central location that is accessible to multiple AI models servers at multiple sites. The AI models server 150 is able to consume/pull/accept these AI model templates and create, train, and deploy the AI models.

The AI models server 150 receives an AI model template, which is a formalized description of an AI model. When the AI model template is selected, the containerized unit for the AI model template is retrieved. At this point, the AI models server 150 accepts and interprets the containerized AI model to instantiate the AI model, connect the AI model to a data source, train the AI model on the data, deploy the AI model as a service, and monitor the AI model at run time as the AI model is being used. Overall, the AI models server 150 serves as an end-to-end lifecycle management for AI models.

With embodiments, the AI models server 150 enables a client to get access to a an AI model template catalog for use in creating AI models, suitable for various applications. The AI models server 150 enables deployment of the AI models, with minimal configuration. The AI models server 150 trains the AI model on the client site, with no need to transport data outside the client site. The AI models server 150 allows AI models to be adapted and configured to the client's specific use cases. The AI models server 150 allows filtering criteria to enable deploying the AI model multiple times, with different sub-groups. The AI models server 150 continuously monitors the AI models for drift that may easily be replaced with updated AI models. The AI models server 150 provides AI model versioning that allows tracking and control on the AI model's performance. The AI models server 150 also provides caching, versioning, feedback collection, and governance.

The AI models server 150 provided by embodiments improves user experience by supporting easy deployment of a variety of ML AI models from an AI model template catalog. The AI models server 150 provides a low-code/low-configuration process so that target personas are application administrators and business users, in addition to highly skilled data scientists. The AI models server 150 provides for scalability and extensibility by providing foundations supporting easy scaling and extension/orchestration of additional services. The AI models server 150 provides comprehensive lifecycle support with integrated services for feedback, monitoring, versioning, governance, caching, etc. The AI models server 150 may be installed alongside existing applications.

With reference to business desires, the AI models server 150 provides a solution that makes AI accessible to many clients and Independent Software Vendors (ISVs), as well as, legacy applications. With reference to feasibility and applicability, the AI models server 150 enables AI models that have not been manually tuned by a data scientist to contribute and improve existing software. With reference to the user interface, the AI models server 150 enables to access a REST endpoint to manage predictions and own the presentation. In response to the accelerated embedding of AI in business applications, embodiments provide for simplification and automation of the AI lifecycle.

Embodiments provide a holistic approach to reduce the technical skill requirements for AI integration in business applications, without sacrificing quality or comprehensiveness.

Formalization of the AI model containment allows establishing a standard technique for training, deploying, servicing, etc. With embodiments, AI models also train on the target data of a client site and continuously adapt to the changing nature of the data.

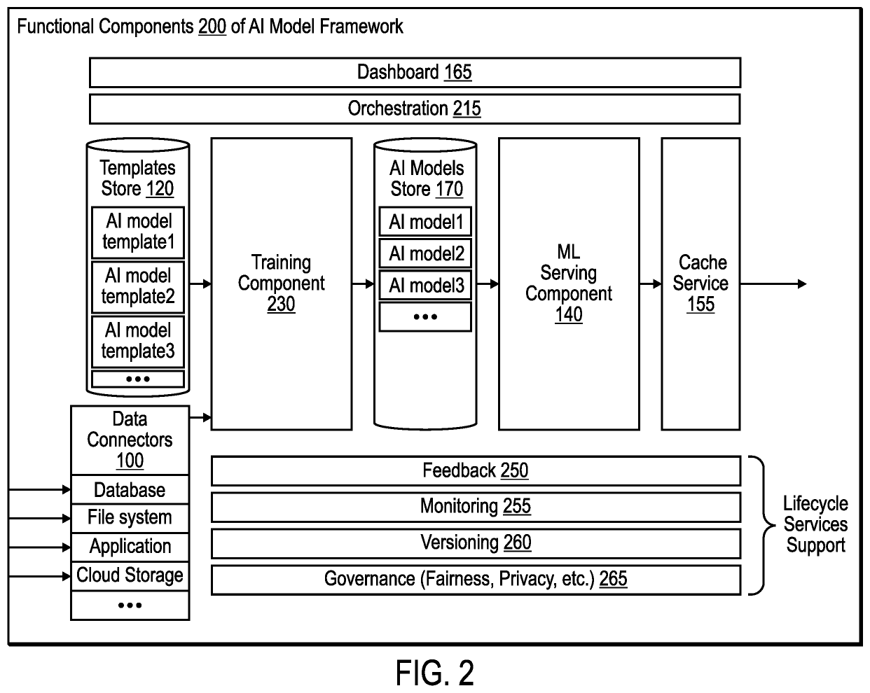

FIG. 2 illustrates, in a block diagram functional components 200 of the AI model framework in accordance with certain embodiments. In FIG. 2, a dashboard 165 is a graphical user interface. The data connectors 100 are used to access data from different data sources, such as a database, a file system, an application, cloud storage, etc. The templates store 120 stores AI model templates for the AI models, such as AI model template1, AI model template2, AI model template3, etc. The orchestration 215 retrieves an AI model template from the templates store 120. The training component 230 receives data from one or more data connectors 100, instantiates an AI model, trains the AI model using the data, and stores the trained AI model in the AI models store 170. The ML serving component 140 serves the AI models from the AI models store 170 via the cache service 155. In addition, the lifecycle services support feedback 250 about the trained AI models, monitoring 255 of the trained AI models during run time, versioning 260 of the trained AI models, and governance 265 (e.g., fairness, privacy, etc.). With embodiments, the data collected by these lifecycle services may be used to improve a particular AI model or AI model template.

In certain embodiments, the AI models server encompasses the orchestrator 215, the cache service 155, the feedback 250, the monitoring 255, the versioning 260, and the governance 265.

With embodiments, the AI models store 170 provides ready AI models, while enabling training at the client site, lifecycle control (with continuous training), custom training (at site, campus, etc.), and versioning (for AI model templates and AI models). The AI models store 170 enables simple AI model deployment from an AI models store (in cloud storage or local storage), where the AI model is configurable (e.g., via configurable parameters). Also, the AI models store 170 enables extendibility with new AI models being added (from in-house or external sources). The AI models store 170 may store trained AI models (trained by the AI models server) and pre-trained AI models (trained by an entity other than the AI models server). The AI models may be private or public.

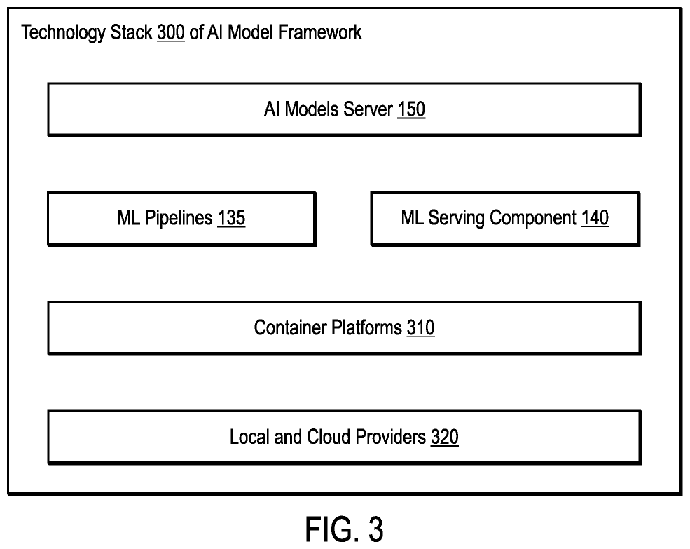

FIG. 3 illustrates, in a block diagram, a technology stack 100 for an AI model framework in accordance with certain embodiments. The technology stack 300 includes an AI models server 150, a Machine Learning (ML) pipelines 135, an ML serving component 140, container platforms 310, and local and cloud providers 320.

Merely to enhance understanding, examples of users who want to use an AI model are provided herein.

For example, an AI model developer (e.g., a researcher at a company) may desire a simple technique to publish an AI model to multiple clients. The AI model developer expects to use the “normal” flow of AI model development that uses a regular (local or cloud) environment with offline files with minimal overhead on top of the regular routine for that AI model developer. The AI model developer also assumes that the code will run un-attended. So, the AI model developer defines clear scenarios for the AI model, defines boundaries for data and validates them, supports different data variations within those boundaries, produces a robust and tolerant code, and produces end-to-end code (e.g., libraries) for training and serving the AI model.

As another example, an ML practitioner (e.g., an engineer) desires to prepare the AI model's code as a re-usable AI model template. The ML practitioner expects to follow a formal definition to: create the AI model template manifests, create a training pipeline (e.g., convert researcher AI model build operations into a build pipeline, test the training pipeline, and perform AI model assessment), package the training and serving code into containers, add pipeline operations for downloading and uploading data, and publish the AI model template to the templates store 120 (i.e., a central repository). Also, the ML practitioner assumes that the AI models server 150 handles other operations (i.e., creating an AI model from the AI model template, training the AI model, deploying the AI model, monitoring the AI model, etc.).

As a further example, an application administrator desires to integrate AI code into an application. The application administrator expects to control the AI lifecycle end-to-end with little AI knowledge. The application administrator gets requirements from the application users, consumes AI models from the AI models store (i.e., a central repository), configures the AI models to the specific business goals, controls and monitors the lifecycle, makes few Information Technology (IT)/business decisions related to AI. The application administrator assumes that there is an initial overhead involved in setting up the AI models server 150, assumes the application will receive a REST endpoint to hook up to the application and that a relevant UI will be created for the application.

As a yet further example, a customer (e.g., a client or business user) desires to easily and seamlessly consume AI capabilities. The customer expects to benefit from AI capabilities with little to no knowledge in AI. The customer provides business guidelines/requirements for the AI model, toggles the usage of AI according to need (“on/off” switch), gets quality predictions with understandable explanations (or if the AI model's performance is poor, prefers not to get any predictions), and provides feedback in order to improve the AI model. The customer expects governance related aspects to be covered and any AI complexity to be hidden from that customer. The customer assumes that the AI model has been properly configured and adapted to a specific use case and that the AI model may be trusted.

Embodiments package an AI model as a shareable AI model template in a way that allows no-code consumption of the AI model, while providing full lifecycle support. Embodiments enable describing an AI model in a formalized manner in order to package that AI model into a transportable containerized unit. Embodiments accept and interpret the containerized AI model component in order to instantiate the AI model, connect the AI model to a data source with data, train the AI model on the data, deploy the AI model as a service, and monitor the AI model at run time. In this manner, embodiments provide end-to-end lifecycle management for AI models.

The packaged AI model, referred to as an AI model template, serves as a blueprint for generating an AI model instance. A system administrator or other user may configure an AI model template to run using the AI models server 150, within an instantiation pipeline, to produce a concrete AI model. The AI model adapts to the data that the AI model is trained on. The AI model is also monitored to identify drift in order to perform re-training and updating of the AI model.

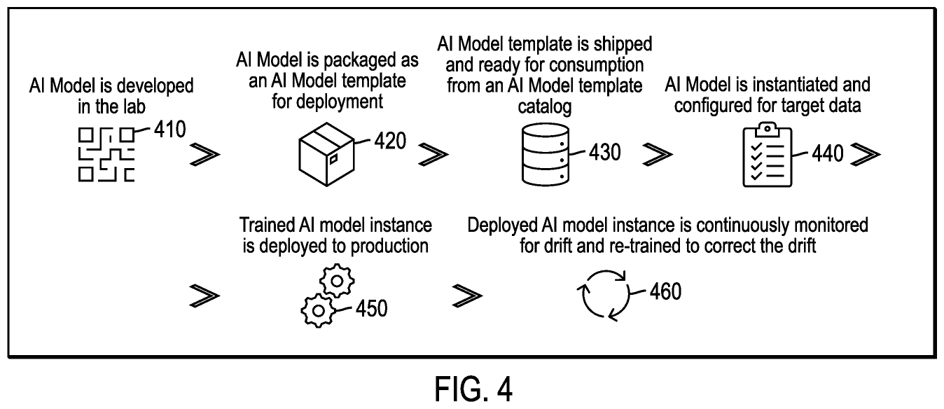

FIG. 4 illustrates an example of a lifecycle of an AI model in accordance with certain embodiments. The AI model is developed in the lab (410). In certain embodiments, the researcher develops the AI model in the lab, ensures that the AI model is adaptable, and defines configuration requirements. The AI model is packaged as an AI model template for deployment (420). In certain embodiments, the ML practitioner prepares the AI model for deployment, defines runtime requirements, and adds pre-processing and post-processing code. In certain embodiments, the AI model template is based on a formal definition of how the AI model is to be defined. The AI model template includes code for instantiating the AI model and metadata. The AI model template is shipped and ready for consumption from an AI model template catalog (430). In certain embodiments, the ML practitioner ships the AI model template. When the AI model template is selected for deployment, the AI model template may require some configuration. The AI model template is assigned a data connector with the proper connection parameters. The AI model template may require additional technical or business parameters for optimal adaptation to the target use case. Then, the AI model is instantiated and trained on the data (430). The trained AI model is deployed to production (450). The deployed AI model instance is continuously monitored for drift and re-trained to correct the drift (460). In certain embodiments, the AI model is selected from an AI model template catalog, instantiated, deployed, and monitored based on a request form an application administrator. Based on the monitoring, the AI model may be upgraded or modified.

The AI models server 150 provides end-to-end lifecycle support, including: monitoring performance and data drift of the AI models, accepting feedback for the AI models, and managing version control for the AI models. The AI models server 150 provides simplicity by providing simple deployment and minimal configuration (e.g., no code), deploying an AI model multiple times (e.g., via instantiations) for different use cases (e.g., different filters and configurations), and avoiding transporting data outside a target (e.g., client) environment for privacy and security. The AI models server 150 provides extendibility and reusability with an AI model template catalog of ready AI model templates (shared by any community and/or vendors), a standard format for publishing AI models (by packaging, transporting, configuring, deploying, monitoring, and receiving feedback), and reusability of components and extendibility of the AI models server 150 with additional services. The AI models server 150 provides scalability utilizing container platforms, ML pipelines, and ML serving components to scale from any to zero (optionally utilizing an AI model mesh).

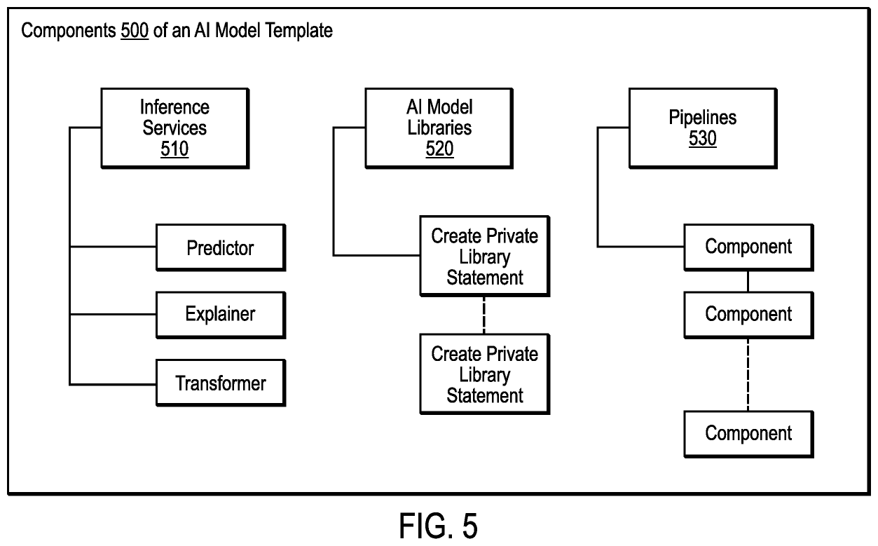

FIG. 5 illustrates components 500 of an AI model template in accordance with certain embodiments. The components 500 include inference services 510, AI models 520, and pipelines 530. The inference services 510 include a predictor service that predicts how an AI model will behave, an explainer service that explains the AI model, and a transformer service that modifies the AI model. The AI model libraries 520 include create private library statements (e.g., joblib binaries). The pipelines 530 include components of the pipeline that make up the set of operation for creating the AI model from the AI model template.

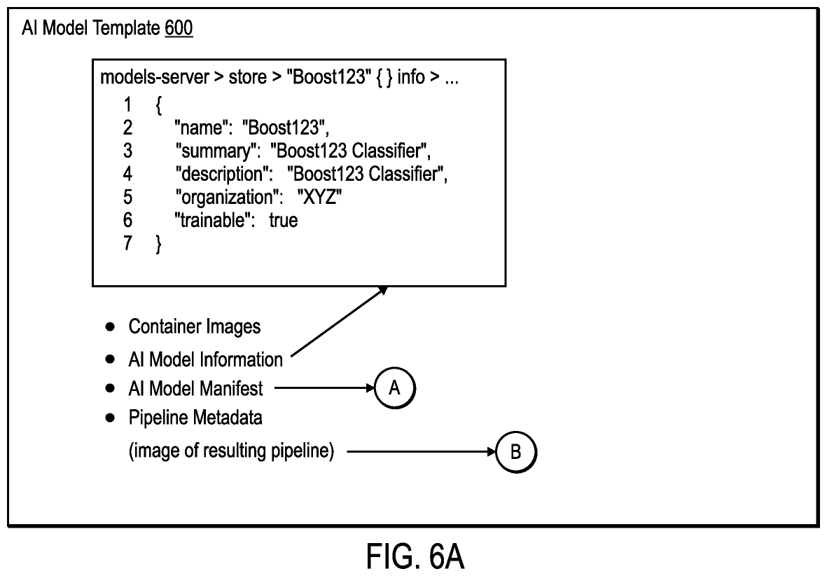

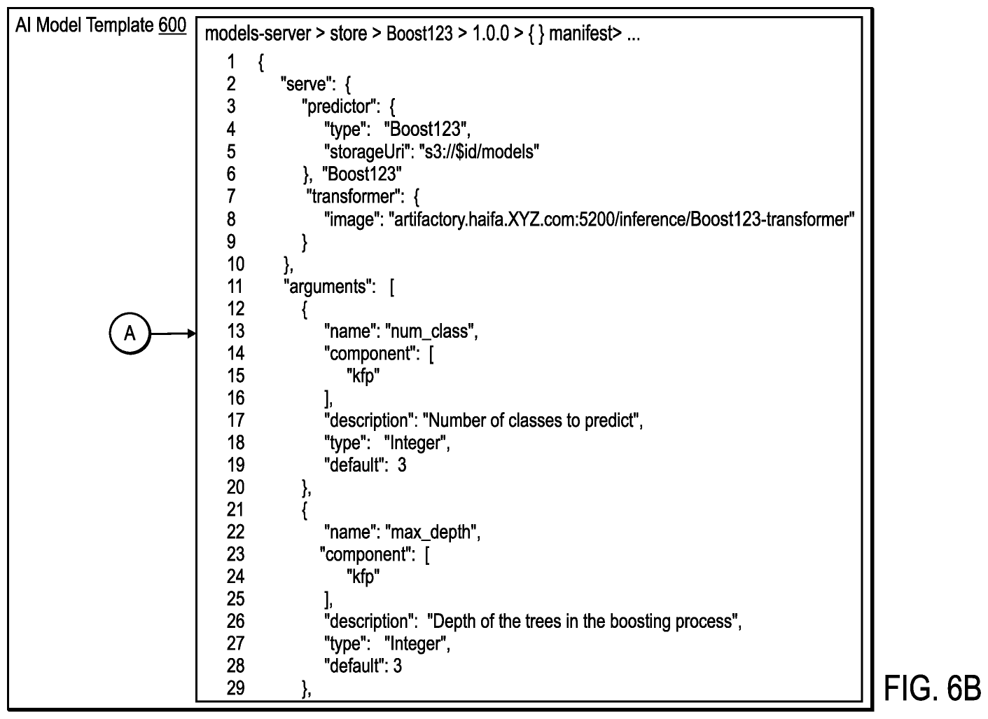

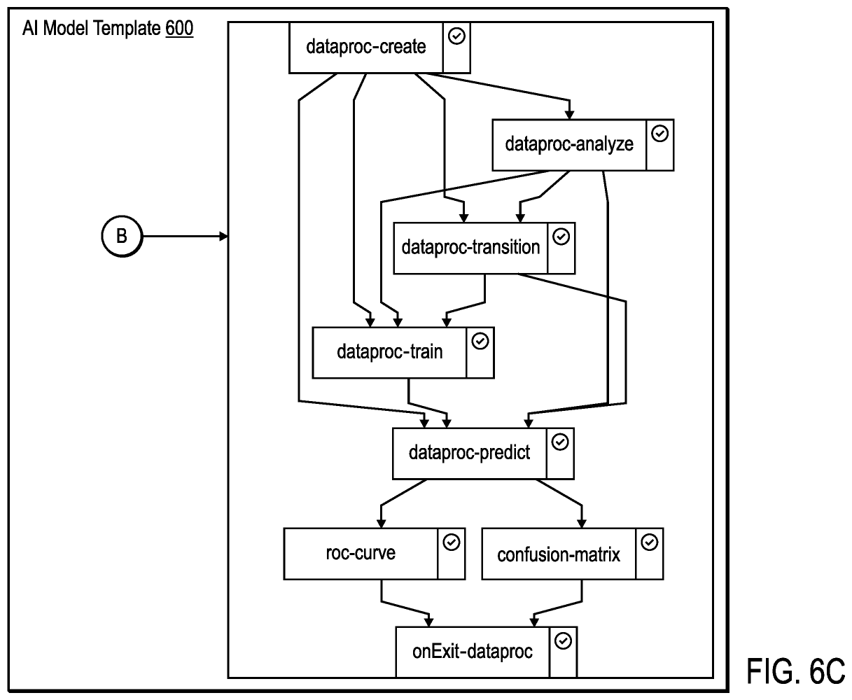

FIGS. 6A, 6B, and 6C illustrate an example AI model template 600 in accordance with certain embodiments. The AI model template 600 includes code and binary execution images, AI model information, an AI model manifest (FIG. 6B), pipeline metadata (including an image of a resulting pipeline (FIG. 6C)).

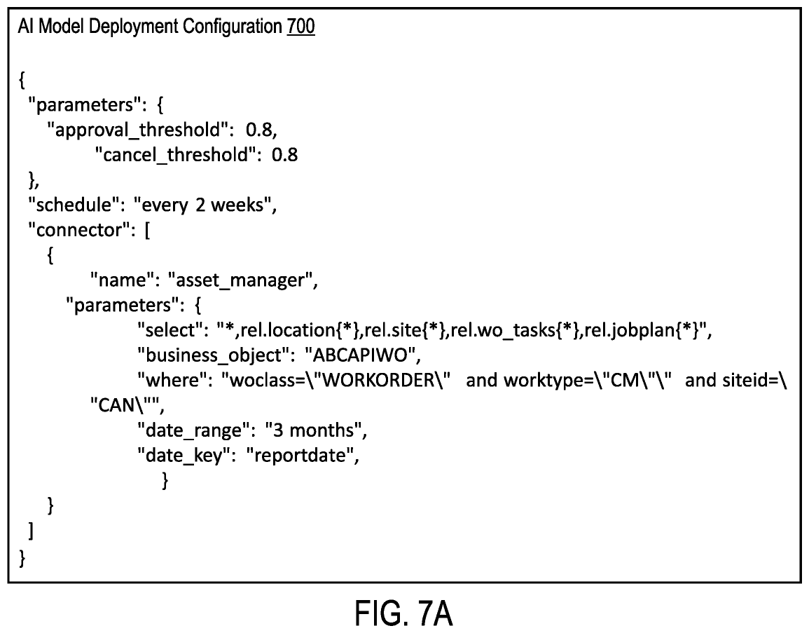

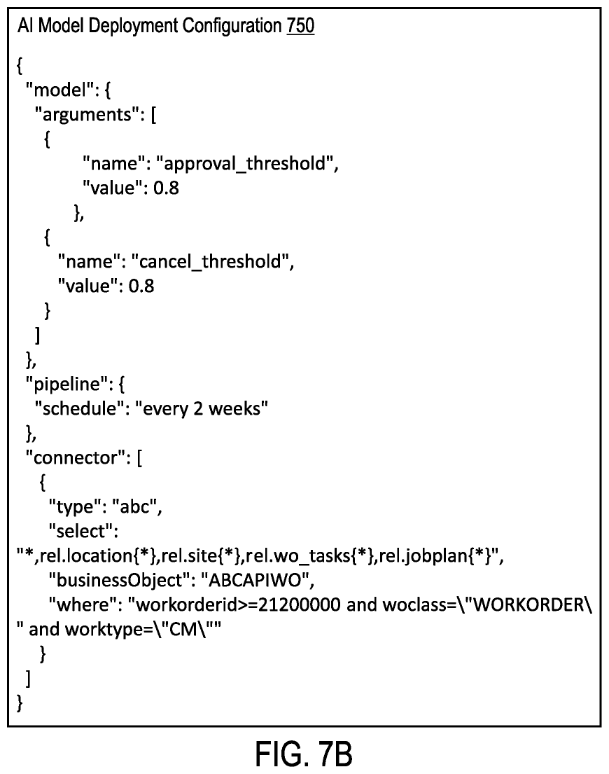

FIGS. 7A and 7B illustrate an example AI model deployment configurations 700, 750 in accordance with certain embodiments. For example, one example AI model deployment configuration 700 includes configurable parameters (e.g., approval_threshold and cancel_threshold), a configurable schedule, and connector data. Another example, AI model deployment configuration 750 includes configurable model arguments, a configurable pipeline schedule, and connector data.

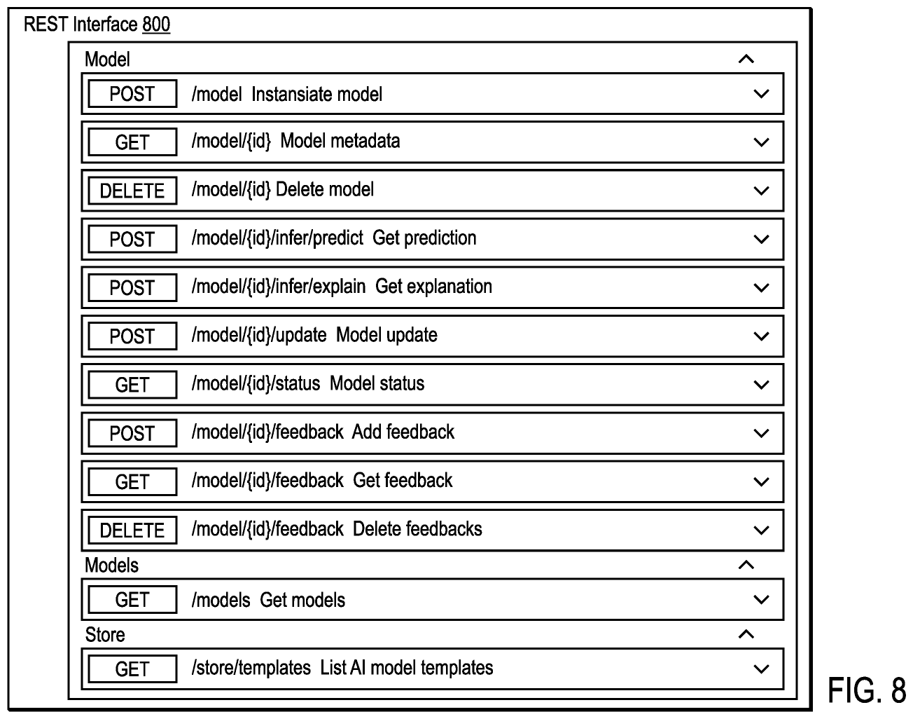

FIG. 8 illustrates a REST interface 800 to the AI models server in accordance with certain embodiments. The REST interface 800 includes operations for an AI model, an operation to retrieve the AI models, and an operation to list the AI model templates. In certain embodiments, the REST interface 800 may be described as an AI models server API.

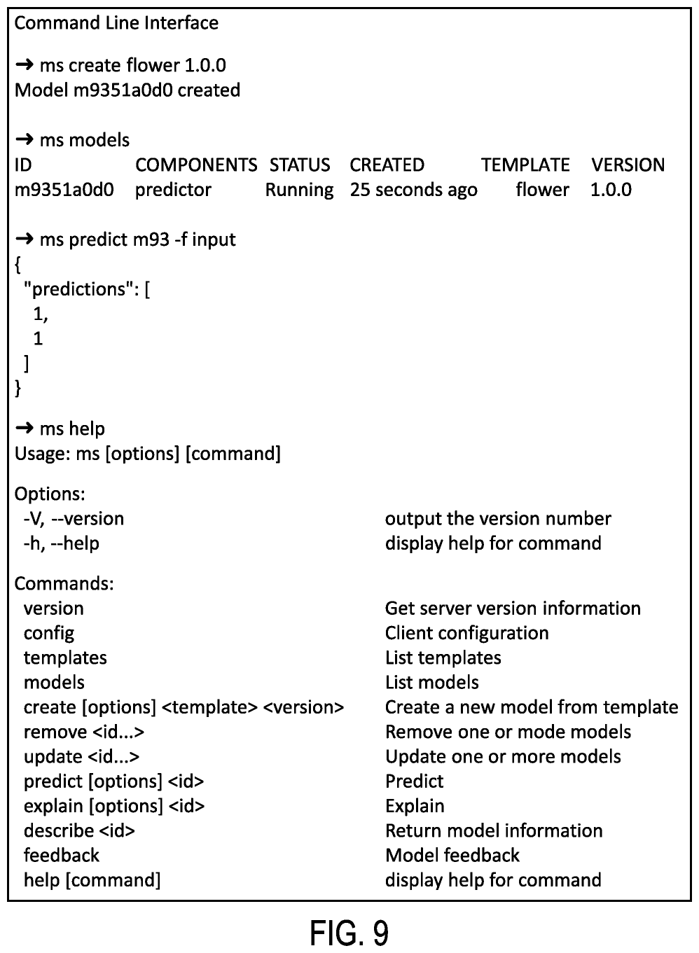

FIG. 9 illustrates a command line interface 900 in accordance with certain embodiments. The command line interface 900 includes operations to create, remove and/or update an AI model and to get information about the AI model.

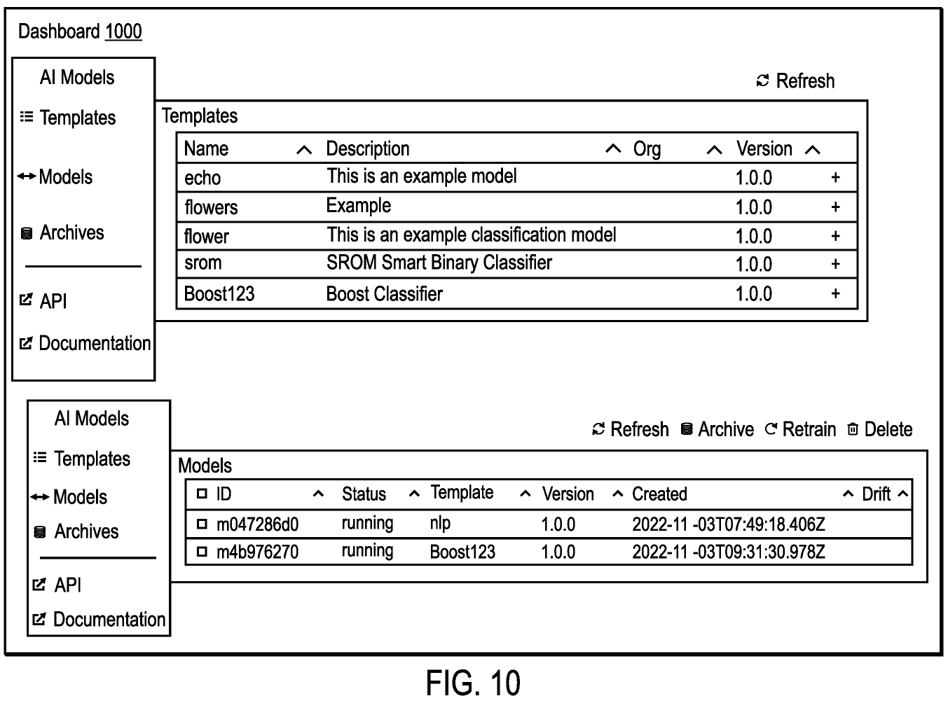

FIG. 10 illustrates an example dashboard 1000 in accordance with certain embodiments. The dashboard 1000 provides access to AI model templates and AI models.

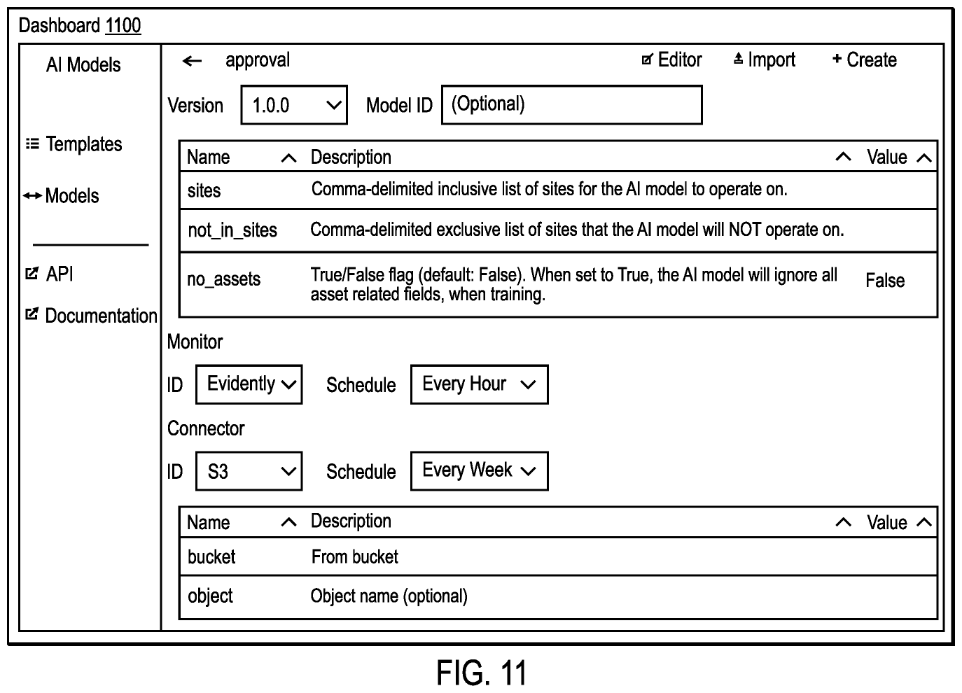

FIG. 11 illustrates another example dashboard 1100 in accordance with certain embodiments. The dashboard 1100 enables instantiating an AI model.

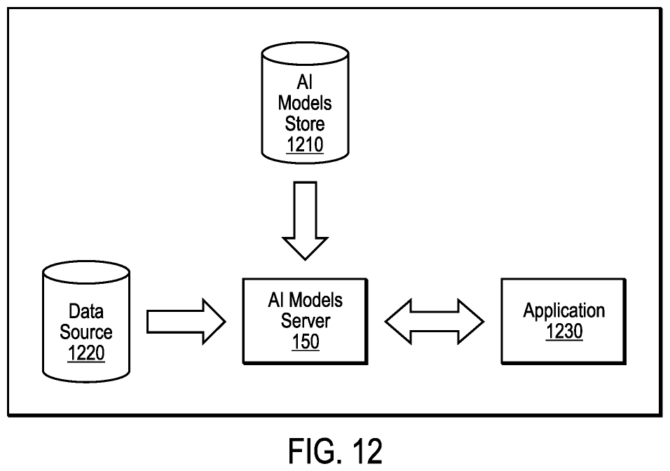

FIG. 12 illustrates the AI models server 150 in accordance with certain embodiments. The AI models server 150 retrieves an AI model from the AI models store 1210 and retrieves data (e.g., client data) from the data source 1220. The AI models server 150 orchestrates training of the AI model using the data.

With embodiments, the AI models server 150 provides common APIs, a feedback loop (to collect input on AI models and further train the AI models based on the feedback), caching, and online AI model monitoring.

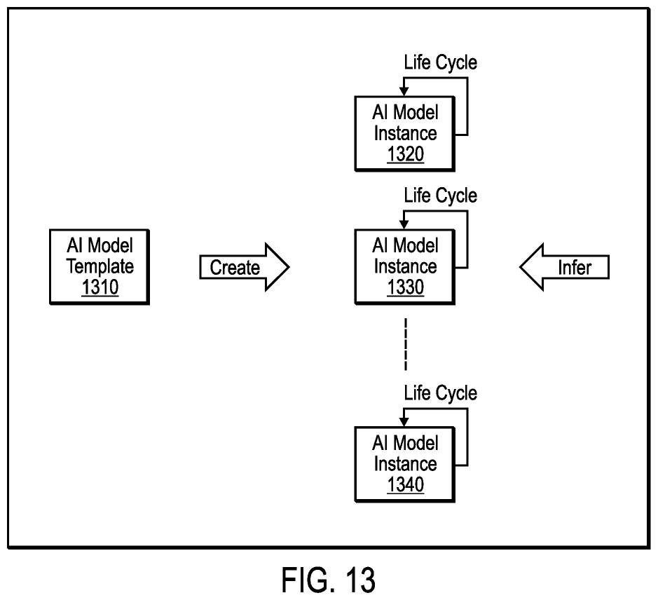

FIG. 13 illustrates instantiation of AI models in accordance with certain embodiments. In FIG. 13, AI model template 1310 is used to create (instantiate) AI model instances 1320, 1330, 1340. Each of the AI model instances 1320, 1330, 1340 may be trained using different client data to customize the AI models for the clients.

In certain embodiments, the AI models server 150 provides a list of AI models via the dashboard, and the AI models server 150 receives selection of an AI model from the list. In certain embodiments, the AI models adapt to lack of fields and missing data. In certain embodiments, the AI models have been tested on multiple client sites and statistics are provided for each of the AI models on the list.

In certain embodiments, as for the runtime environment, there is no configuration by a user. Also, AI models that do not meet runtime requirements are not provided on the list of AI models. The runtime environment may include libraries, dependencies, out of the box libraries, optional dynamically loaded libraries, optional additional code, etc.

With reference to the data used by the AI model, the query fields may be pre-defined, there may be missing fields or values, and there may be redundant fields (which may be ignored). Also, the user selecting the AI model may define filter criteria (e.g., a WHERE clause) to indicate that the AI model is to work on a subset of data.

With embodiments, any pre-processing or post-processing is taken into consideration, so that the user does not provide any input for this. The pre-processing may include a set of utilities (e.g., removal of duplicates, cardinality, etc.) for transforming the data. The post-processing may include support for custom code (e.g., to define an interface).

In certain embodiments, with reference to lifecycle policies, the user may provide input for parameters to adjust the AI model's performance with a training look-back period and prediction look-forward and re-train the lifecycle/policy based on a timeline, replacement criteria, and quality threshold In certain embodiments, this defines the extent of the time windows upon which the AI model relies on for training and for validation (testing) before producing the AI model and a report on the performance of the AI model. For example, it is possible that a certain AI model may be trained with at least 1 year of historic data, while another AI model may be trained with one week of historic data. The AI models server 150 monitors AI models for real-time quality.

In certain embodiments, there is a defined set of allowed types. In certain embodiments, different AI models support different data types, and this is reflected through the list of available data connectors for the AI model. For example, image AI models show data connectors that may pull image data.

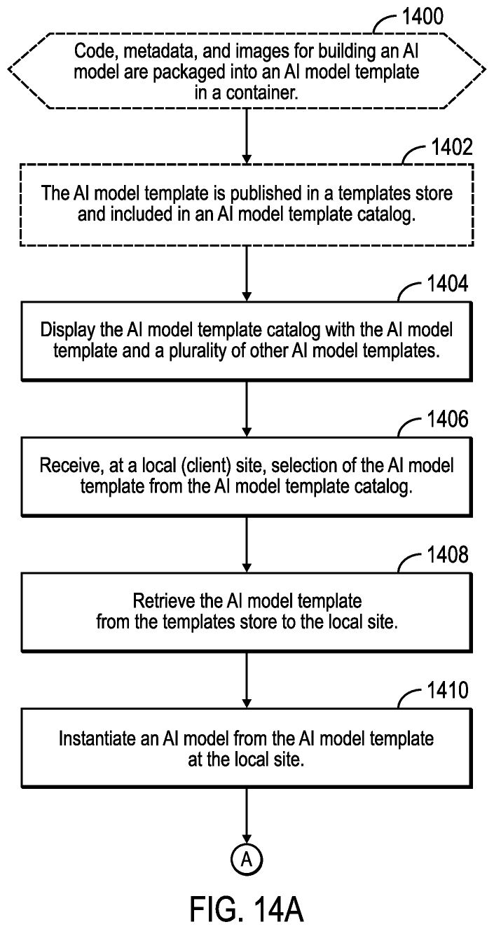

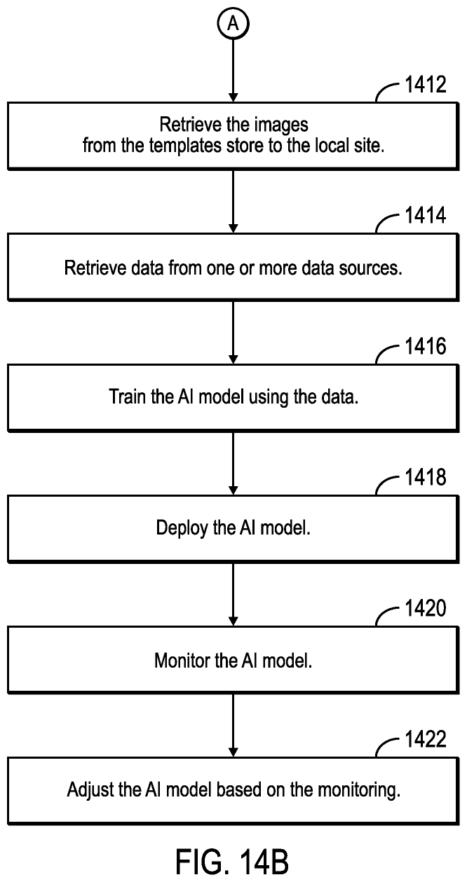

FIGS. 14A and 14B illustrate, in a flowchart, operations for lifecycle management of an AI model in accordance with certain embodiments. (Initially, in block 1400, code, metadata, and binary execution images for building an AI model are packaged into an AI model template in a container. In block 1402, the AI model template is published in a templates store and included in an AI model template catalog.

Embodiments provide a tool (external to the AI models server) for packaging AI model code as an AI model template. This packaging may also be done manually, as long the formal structure/definition is followed. This enables an AI model to be described in a formalized manner as an AI model template and enables packaging the AI model template into a transportable unit.

In block 1404, the AI models server 150 displays the AI model template catalog with the AI model template and a plurality of other AI model templates. In block 1406, the AI models server 150 receives, at a local (e.g., client) site, selection of the AI model template from the AI model template catalog. In block 1408, the AI models server 150 retrieves the AI model template from the templates store (at an external or remote site) to the local site. In block 1410, the AI models server 150 instantiates an AI model from the AI model template at the local site. From block 1410 (FIG. 14A), processing continues to block 1412 (FIG. 14B).

In block 1412, the AI models server 150 retrieves the binary execution images from the templates store to the local site. With embodiments, the binary execution images may be described as files containing the binary code used for creating the containers. In block 1414, the AI models server 150 uses one or more data connectors to retrieve data from one or more data sources (i.e., local (“client”) data from local data sources at the client site). In block 1416, the AI models server 150 uses the ML pipeline to train the AI model using the data. In block 1418, the AI models server 150 deploys the AI model. In block 1420, the AI models server 150 monitors the AI model. In block 1422, the AI models server 150 adjusts the AI model based on the monitoring. For example, the monitoring may identify drift, and the AI model is adjusted to correct the drift.

In certain embodiments, orchestrating the lifecycle of the AI model includes the operations of blocks 1410-1422.

The AI models server 150 orchestrates AI model lifecycle management at client sites. The AI models server 150 enables easy selection of an AI model template and enables training and deployment of an AI model from the selected AI model template. The AI models server 150 accepts and interprets the containerized AI model to instantiate the AI model, connect the AI model to a data source, train the AI model on the data from the data source, deploy the AI model as a service, and monitor the AI model at run time.

With embodiments, a system administrator may configure an AI model template to run using the lifecycle management system, within an instantiation pipeline and produce a concrete AI model. With embodiments, the AI model adapts to the data it was trained on, and the AI model is monitored to identify drift to perform re-training and updating of the AI model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

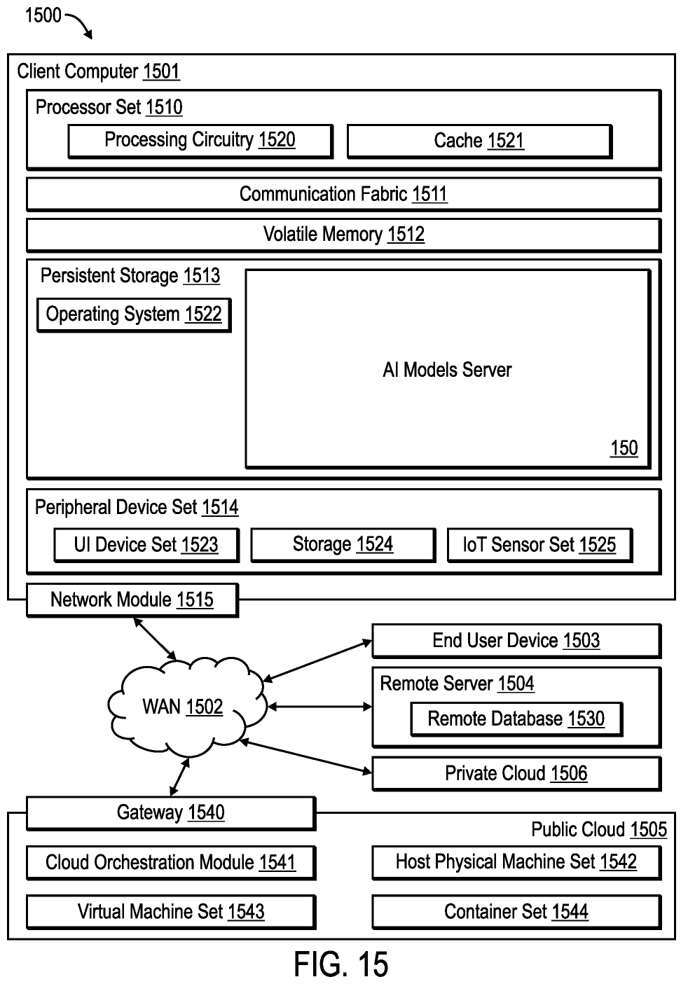

FIG. 15 illustrates a computing environment 1500 in accordance with certain embodiments. Computing environment 1500 contains an example of an environment for the execution of at least some of the computer code involved in performing the inventive methods, such as lifecycle models server code 1600. In addition to block 1600, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1513 (including operating system 1522 and block 1600, as identified above), peripheral device set 1514 (including user interface (UI) device set 1523, storage 1524, and Internet of Things (IoT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1530. As is well understood in the art of computer technology, and depending upon the technology, performance of a computer-implemented method may be distributed among multiple computers and/or between multiple locations. On the other hand, in this presentation of computing environment 1500, detailed discussion is focused on a single computer, specifically computer 1501, to keep the presentation as simple as possible. Computer 1501 may be located in a cloud, even though it is not shown in a cloud in FIG. 15. On the other hand, computer 1501 is not required to be in a cloud except to any extent as may be affirmatively indicated.

PROCESSOR SET 1510 includes one, or more, computer processors of any type now known or to be developed in the future. Processing circuitry 1520 may be distributed over multiple packages, for example, multiple, coordinated integrated circuit chips. Processing circuitry 1520 may implement multiple processor threads and/or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set may be located “off chip.” In some computing environments, processor set 1510 may be designed for working with qubits and performing quantum computing.

Computer readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1521 and the other storage media discussed below. The program instructions, and associated data, are accessed by processor set 1510 to control and direct performance of the inventive methods. In computing environment 1500, at least some of the instructions for performing the inventive methods may be stored in block 1600 in persistent storage 1513.

COMMUNICATION FABRIC 1511 is the signal conduction path that allows the various components of computer 1501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1512 is any type of volatile memory now known or to be developed in the future. Examples include dynamic type random access memory (RAM) or static type RAM. Typically, volatile memory 1512 is characterized by random access, but this is not required unless affirmatively indicated. In computer 1501, the volatile memory 1512 is located in a single package and is internal to computer 1501, but, alternatively or additionally, the volatile memory may be distributed over multiple packages and/or located externally with respect to computer 1501.

PERSISTENT STORAGE 1513 is any form of non-volatile storage for computers that is now known or to be developed in the future. The non-volatility of this storage means that the stored data is maintained regardless of whether power is being supplied to computer 1501 and/or directly to persistent storage 1513. Persistent storage 1513 may be a read only memory (ROM), but typically at least a portion of the persistent storage allows writing of data, deletion of data and re-writing of data. Some familiar forms of persistent storage include magnetic disks and solid state storage devices. Operating system 1522 may take several forms, such as various known proprietary operating systems or open source Portable Operating System Interface-type operating systems that employ a kernel. The code included in block 1600 typically includes at least some of the computer code involved in performing the inventive methods.

PERIPHERAL DEVICE SET 1514 includes the set of peripheral devices of computer 1501. Data communication connections between the peripheral devices and the other components of computer 1501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1523 may include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 may be persistent and/or volatile. In some embodiments, storage 1524 may take the form of a quantum computing storage device for storing data in the form of qubits. In embodiments where computer 1501 is required to have a large amount of storage (for example, where computer 1501 locally stores and manages a large database) then this storage may be provided by peripheral storage devices designed for storing very large amounts of data, such as a storage area network (SAN) that is shared by multiple, geographically distributed computers. IoT sensor set 1525 is made up of sensors that can be used in Internet of Things applications. For example, one sensor may be a thermometer and another sensor may be a motion detector.

NETWORK MODULE 1515 is the collection of computer software, hardware, and firmware that allows computer 1501 to communicate with other computers through WAN 1502. Network module 1515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN 1502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501), and may take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 may be a client device, such as thin client, heavy client, mainframe computer, desktop computer and so on.

REMOTE SERVER 1504 is any computer system that serves at least some data and/or functionality to computer 1501. Remote server 1504 may be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data may be provided to computer 1501 from remote database 1530 of remote server 1504.

PUBLIC CLOUD 1505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1505 is performed by the computer hardware and/or software of cloud orchestration module 1541. The computing resources provided by public cloud 1505 are typically implemented by virtual computing environments that run on various computers making up the computers of host physical machine set 1542, which is the universe of physical computers in and/or available to public cloud 1505. The virtual computing environments (VCEs) typically take the form of virtual machines from virtual machine set 1543 and/or containers from container set 1544. It is understood that these VCEs may be stored as images and may be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware, and firmware that allows public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1505 and private cloud 1506 are both part of a larger hybrid cloud.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

### Examples

The foregoing description provides examples of embodiments of the invention, and variations and substitutions may be made in other embodiments. Several examples will now be provided to further clarify various aspects of the present disclosure: Example 1: A computer-implemented method, comprising operations for receiving selection of an Artificial Intelligence (AI) model template at a local site, wherein the AI model template is created at a remote site and is packaged in a transportable container. The computer-implemented method further comprises operations for retrieving the AI model template in the transportable container. The computer-implemented method further comprises operations for orchestrating a lifecycle of an AI model by: instantiating the AI model from the AI model template, retrieving data from one or more local data sources, training the AI model using the data, deploying the AI model as a service, monitoring the AI model for drift, and, in response to identifying drift, re-training the AI model.

Example 2: The limitations of any of Examples 1 and 3-7, and wherein the computer-implemented method further comprises operations for displaying the AI model template in an AI model template catalog.

Example 3: The limitations of any of Examples 1-2 and 4-7, wherein the AI model is configurable with configurable parameters.

Example 4: The limitations of any of Examples 1-3 and 5-7, wherein, for orchestrating the lifecycle of the AI model, the computer-implemented method further comprises operations for providing lifecycle services of caching, versioning, and governance at the local site.

Example 5: The limitations of any of Examples 1-4 and 6-7, wherein a machine learning pipeline is used to perform the training of the AI model.

Example 6: The limitations of any of Examples 1-5 and 7, wherein the computer-implemented method further comprises operations for receiving feedback on the AI model and updating the AI model template and updating the AI model based on the feedback.

Example 7: The limitations of any of Examples 1-6, wherein the AI model template is a formalized description of the AI model that allows transportability of the model, and wherein code, metadata, and binary execution images are packaged in the AI model template.

Example 8: A computer program product, the computer program product comprising a computer readable storage medium having program code embodied therewith, the program code executable by at least one processor to perform a method according to any one of Examples 1-7.

Example 9: A computer system comprising one or more processors, one or more computer-readable memories and one or more computer-readable, tangible storage devices, and program instructions, stored on at least one of the one or more computer-readable, tangible storage devices for execution by at least one of the one or more processors via at least one of the one or more computer-readable memories, to perform a method according to any of Examples 1-7.

What is claimed is:

1. A computer-implemented method, comprising operations for:
receiving selection of an Artificial Intelligence (AI) model template at a local site, wherein the AI model template is created at a remote site and is packaged in a transportable container;
retrieving the AI model template in the transportable container; and
orchestrating a lifecycle of an AI model by:
instantiating the AI model from the AI model template;
retrieving data from one or more local data sources;
training the AI model using the data;
deploying the AI model as a service;
monitoring the AI model for drift; and
in response to identifying drift, re-training the AI model.

2. The computer-implemented method of claim 1, further comprising operations for:
displaying the AI model template in an AI model template catalog.

3. The computer-implemented method of claim 1, wherein the AI model is configurable with configurable parameters.

4. The computer-implemented method of claim 1, wherein orchestrating the lifecycle of the AI model further comprising operations for:
providing lifecycle services of caching, versioning, and governance at the local site.

5. The computer-implemented method of claim 1, wherein a machine learning pipeline is used to perform the training of the AI model.

6. The computer-implemented method of claim 1, further comprising operations for:
receiving feedback on the AI model; and
updating the AI model template and updating the AI model based on the feedback.

7. The computer-implemented method of claim 1, wherein the AI model template is a formalized description of the AI model that allows transportability of the model, and wherein code, metadata, and binary execution images are packaged in the AI model template.

8. A computer program product, the computer program product comprising a computer readable storage medium having program code embodied therewith, the program code executable by at least one processor to perform operations for:
receiving selection of an Artificial Intelligence (AI) model template at a local site, wherein the AI model template is created at a remote site and is packaged in a transportable container;
retrieving the AI model template in the transportable container; and
orchestrating a lifecycle of an AI model by:
instantiating the AI model from the AI model template;
retrieving data from one or more local data sources;
training the AI model using the data;
deploying the AI model as a service;
monitoring the AI model for drift; and
in response to identifying drift, re-training the AI model.

9. The computer program product of claim 8, wherein, for orchestrating the lifecycle of the AI model, the program code is executable by the at least one processor to perform operations for:
displaying the AI model template in an AI model template catalog.

10. The computer program product of claim 8, wherein the AI model is configurable with configurable parameters.

11. The computer program product of claim 8, wherein, for orchestrating the lifecycle of the AI model, the program code is executable by the at least one processor to perform operations for:
providing lifecycle services of caching, versioning, and governance at the local site.

12. The computer program product of claim 8, wherein a machine learning pipeline is used to perform the training of the AI model.

13. The computer program product of claim 8, wherein the program code is executable by the at least one processor to perform operations for:
receiving feedback on the AI model; and
updating the AI model template and updating the AI model based on the feedback.

14. The computer program product of claim 8, wherein the AI model template is a formalized description of the AI model that allows transportability of the model, and wherein code, metadata, and binary execution images are packaged in the AI model template.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
receiving selection of an Artificial Intelligence (AI) model template at a local site, wherein the AI model template is created at a remote site and is packaged in a transportable container;
retrieving the AI model template in the transportable container; and
orchestrating a lifecycle of an AI model by:
instantiating the AI model from the AI model template;
retrieving data from one or more local data sources;
training the AI model using the data;
deploying the AI model as a service;
monitoring the AI model for drift; and
in response to identifying drift, re-training the AI model.

16. The computer system of claim 15, wherein the operations further comprise:
displaying the AI model template in an AI model template catalog.

17. The computer system of claim 15, wherein the AI model is configurable with configurable parameters.

18. The computer system of claim 15, wherein, for orchestrating the lifecycle of the AI model, the operations further comprise:
providing lifecycle services of caching, versioning, and governance at the local site.

19. The computer system of claim 15, wherein a machine learning pipeline is used to perform the training of the AI model.

20. The computer system of claim 15, wherein the operations further comprise:
receiving feedback on the AI model; and
updating the AI model template and updating the AI model based on the feedback.
